(19) United States
(12) Patent Application Publication
(10) Pub. No.: US 2008/0126514 A1
(43) Pub. Date: May 29, 2008

(54) METHOD AND APPARATUS FOR CREATING AND MANIPULATING DIGITAL IMAGES

(76) Inventor: Michael Betts, Toronto (CA)

Correspondence Address: BENNETT JONES LLP, 3400 ONE FIRST CANADIAN PLACE, PO BOX 130, TORONTO, ON, M5X 1A4, omitted

(21) Appl. No.: 11/771,319

(22) Filed: Jun. 29, 2007

Related U.S. Application Data
(60) Provisional application No. 60/817,354, filed on Jun. 30, 2006.

(51) Int. Cl. G06F 15/16

(52) U.S. Cl. 709/217; 709/203

(57) ABSTRACT

A system and method for creating an image object or set from a plurality of captured images. The system comprises an interface for receiving the captured images from a client location, a storage device for storing the images and a processor for converting the received images into a format compatible with the image object. The system may include a user interface for accessing the image object and manipulating or otherwise managing the image object (or image set). According to one embodiment, the system comprises a network-based implementation, such as a web-based implementation for the Internet.

### FIELD OF THE INVENTION

The present invention relates to digital data processing, more particularly to a method and apparatus for creating and/or manipulating image data objects from still, captured or stored images.

### BACKGROUND OF THE INVENTION

Data image files are typically displayed in a static format with limited or no ability to manipulate or manage the data images. There are known technologies that provide for manipulation of photographic data images, which have been pre-loaded into specific applications. There are also known technologies that allow for rapid transfer of data through compression and flash based systems.

It will be appreciated that almost any transfer of image data requires high bandwidth. The volume of data further increases if moving images are being used, for example, images which can be manipulated through a user interface. This slows or hinders the ability of a user to easily or usefully manipulate the image utilizing existing Internet based applications. While there are known technologies which allow “pre-loaded” and compressed image materials to be manipulated, there still remains a need in the art for a method and apparatus for creating and manipulating high-resolution interactive web objects from still images for industrial and commercial applications.

### BRIEF SUMMARY OF THE INVENTION

The present invention comprises a system and method for converting captured or still images into one or more image sets or objects and manipulating and/or managing the image set or objects.

According to a first embodiment, the present invention provides a system for creating image objects from a plurality of captured images, the system comprises: an upload communication interface for receiving the captured images from a client location; a processor, the processor including the communication interface and memory for storing the received images; the processor including a component for converting the received images into a format compatible with the image object; said processor including a download communication interface for providing a client with access to the image objects.

According to another embodiment, the present invention provides a method for creating image objects from a plurality of captured images, the method comprises the steps of: transferring the captured images to a processor; the processor storing the captured images; the processor converting the captured images into a format compatible with the associated image object; the processor being responsive to a client request for retrieving the image object.

According to another embodiment, the present invention provides a system for creating an image set from a plurality of captured images, the system comprises: a network interface for receiving the captured images from one or more clients coupled to a network; a processor having a queuing engine for queuing the captured images received from the one or more clients; the processor including an image processing engine for processing the captured images into one or more image sets; a storage device for storing the one or more image sets; and the network interface including a module for retrieving the one or more image sets in response to a request from the one or more clients.

According to another embodiment, the present invention provides a method for creating an image set from a plurality of images wherein the images are received from one or more users via a network connection, the method comprises the steps of: processing a request from the user wherein the request is received via the network connection; establishing a network session for the user; receiving one or more images from the user during the network session; queuing the received images if images are received from more than one user; processing the received images into one or more image sets; and storing the one or more image sets in memory.

### BRIEF DESCRIPTION OF THE DRAWINGS

Reference is next made to the drawings, which show by way of example, embodiments of the present invention, and in which:

FIG. 1 shows in block diagram form a system for creating and manipulating image objects according to an embodiment of the invention;

FIG. 2 shows in flowchart form a process for capturing and processing images according to an embodiment of the invention;

FIG. 3 shows in diagrammatic form a network-based image management system according to another embodiment of the invention; and

FIG. 4 shows in flowchart form a process for managing access and content for the network-based image management system according to an embodiment of the invention.

In the drawings, like numerals or references are used for like corresponding parts of the accompanying drawings.

### DETAILED DESCRIPTION OF EMBODIMENTS OF THE INVENTION

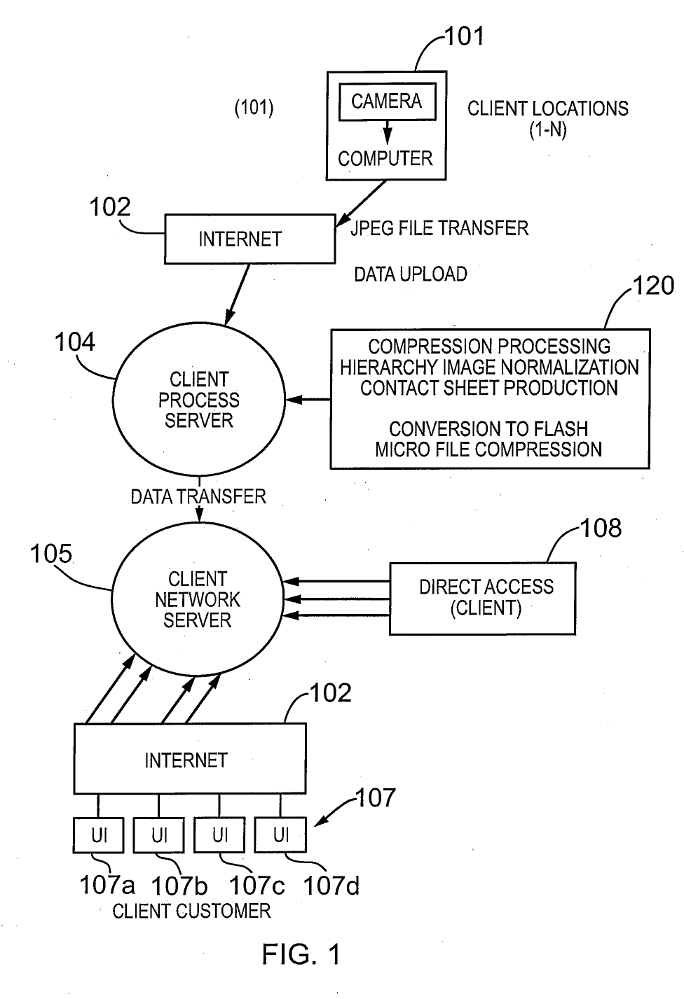

Reference is first made to FIG. 1, which shows in block diagram form a system for creating and manipulating image objects according to an embodiment of the invention. The system is indicated generally by reference 100 and comprises one or more client locations 101, a client process server 104, a client network server 105, and one or more client customer interfaces 107. The client locations 101, for example, client computers or client sites, connect to the client process server 104 via the Internet 102. Similarly, the client customers 107 can access the client network 105 via the Internet 102. While described in the context of the Internet 102, the system 100 may be implemented using other network architectures or types, for example, a wide area network (WAN) or a local area network (LAN) or a private network.

The client site 101 includes apparatus, for example, a camera and a computer, for capturing or generating still images. The still images are stored in a digital format. The client site 101 utilizes the Internet 102 (or other communication network or channel) to connect with the client process server 104. The client site 101 then executes a computer program or module to upload the still images to the client process server 104, for example, using a JPEG file transfer protocol or mechanism. In one embodiment, the client process server 104 includes multiple input ports or interfaces to allow multiple clients or client sites 101 to connect the client process server 104 at the same time.

The client process server 104 comprises a computer or computers. The client processor server 104 executes one or more computer programs or software modules or code components (indicated generally by block 120 in FIG. 1), which, as will be described in more detail below, provide a compression hierarchy processing function, image normalization, a contact sheet production function, and a flash micro file compression conversion function. The converted files or image data are transferred to the client network server 105.

The client customer 107, indicated individually by references 107a, 107b, 107c and 107d in FIG. 1, access the images, e.g. image objects, on the client network server 105 via the Internet 102. As depicted in FIG. 1, the client network server 105 may include a direct access interface module 108. The direct access interface module 108 allows clients, i.e. via computers at the client locations 101, to directly access the client network server 105, for example, via a dedicated communication link or channel. The client customer 107 comprises a computer with a user interface or UI for accessing the client network server 105. The UI may comprise a browser based software module for an Internet implementation. The client customer uses the UI to view, display or otherwise manipulate the image data or objects.

For the embodiment depicted in FIG. 1, the client process server 104 and the client network server 105 are shown as separate machines or modules. According to another embodiment, the client process server 104 and the client network server 105 may be combined on a single machine, i.e. computing apparatus.

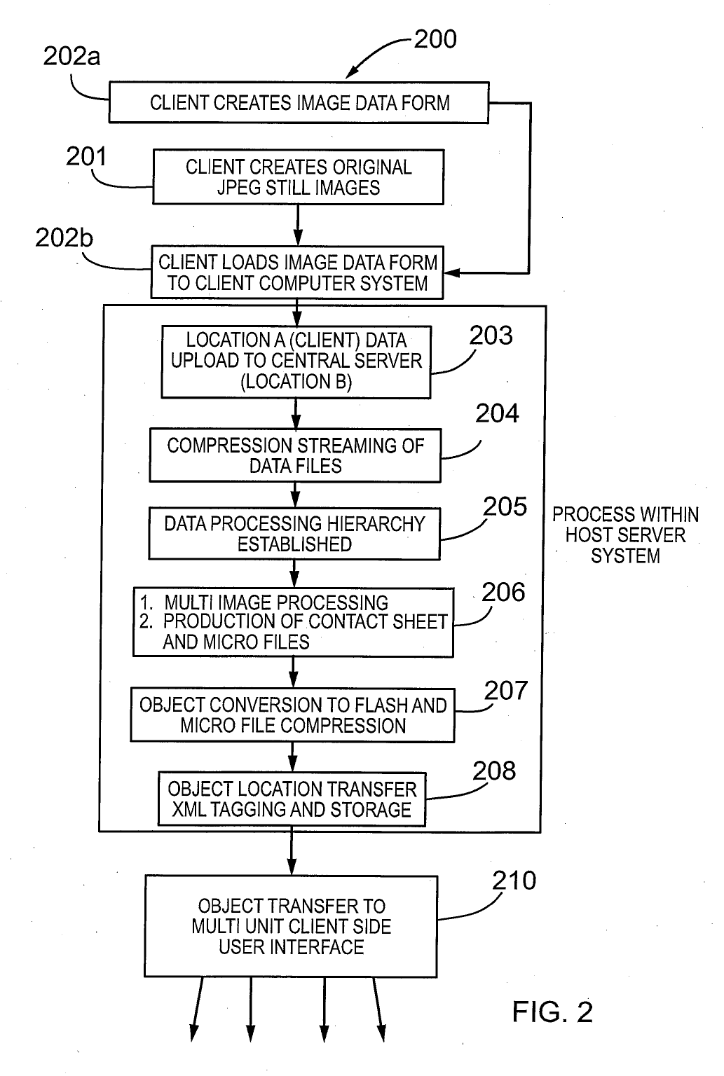

Reference is next made to FIG. 2, which shows in flowchart form the processing steps and functional blocks for data processing according to an embodiment of the present invention. The process is indicated generally by reference 200.

As indicated by block 201, the first step comprises the client creating the still images, for example, using a camera or other known image capture devices and for example according to the JPEG standard. The still images are stored in digital format in the computer at the client location 101 (FIG. 1). The client creates an “image data form” as indicated by block 202. According to one embodiment, the image data form defines output characteristics for the image object, such as, window viewing size, aesthetic skinning, and image dynamics, for example, the number of views in the interactive “deck” through the x and y axis of viewing perspectives. As indicated in block 202b, the client load the image data form at the client location computer, and according to an embodiment of the invention, the production data (i.e. image file data) is tagged along with the image deck at upload to facilitate more efficient “server side” stills to interactive image conversion.

As described above with reference to FIG. 1, the system 100 according to one embodiment allows multiple users to simultaneously login to the client processor server 104 (FIG. 1). According to another aspect, the UI 107 (FIG. 1) allows a client customer to verify the status of their upload(s), for example managed by destination and/or object number, which can facilitate “client side” control during the process.

Referring back to FIG. 2, the client process server 104 (FIG. 1) imports the data uploaded from the client and stores the image data in memory (block 203). The client process server 104 then commences processing of the image files or image data. As indicated in block 204, the processing in the client process server 104 includes compression streaming of the data files. The client process server 104 executes a computer program or software module to establish a data processing hierarchy as indicated in block 205. The data processing hierarchy defines an order or sequence for processing of the image data files, for example, image data files uploaded by multiple users, i.e. client stations 101 (FIG. 1). According to one embodiment, individual delivery destinations (i.e. client locations) are indexed by destination volume estimates and deliverable timelines. The client process server 104 interprets volume inflow priorities and shortlist deliverables in order to prioritize which client production should be higher on postproduction hierarchy. According to another embodiment, the data processing hierarchy is determined based on internal factors or parameters, external factors or parameters, or a combination of both. For example, the internal factors may include data processing requirements or requests received from multiple sources or clients and external factors such as deadlines or deliverable dates requested by one or more of the clients. This information is utilized to generate a data processing hierarchy based on particular requirements.

As indicated in block 206, the computer software executed on the client process server 104 provides the capability to run multiple processes simultaneously, for example, in a multi-layer process, to process the digital image files. The client process server 104 executes computer software or a program module that ties the image files together into a navigable contact sheet. The contact sheet provides a mechanism for managing image data associated with the image data objects and comprises a preliminary view which is viewed, for example, at the client customer 107 (FIG. 1). According to one embodiment, the contact sheet is designed or defined according to preset production dynamics, for example, according to the image data form from the client. As indicated in block 206, the client process server 104 splits the image files into a sequence of unique micro-files for transfer, i.e. streaming download, to the client network server 105 (FIG. 1). The contact sheet data is indexed with the appropriate micro-file data sequence, for example, to support interaction between the contact sheet and the download streaming files. According to another embodiment, the computer software executed on the client process server 104 may include an image normalization function, for example, as indicated in block 120 of FIG. 1. The image normalization functions to normalize the image(s) and may be implemented in known manner.

After the execution of the above processes, the client process server 104 executes software, as indicated in block 207, to convert the data to a flash recognizable output file. As indicated in block 208, the data is stored to a predetermined destination within the network (e.g. the client network server 105 in FIG. 1) and allows client linking or access via the Internet 102 (FIG. 1), for example, using XML in a web-based browser implementation for the user interface 107 (FIG. 1).

It will be appreciated that the image data as processed comprises an individually stored and fully interactive object, typically of significant file size. In view of the number of objects that need to be viewed simultaneously by a group of users in a typical operating environment, for example, an industrial application, such as an automotive auction or an industrial equipment liquidation, a compression based mechanism is used for delivering the object data in order to manage the bandwidth requirements and/or the capacity for the client network. According to one embodiment, the system 100 utilizes a sequential “on demand” download structure that only delivers portions of image content when delivered by micro-file. Instructions for determination of file data download are delivered to the data processing services through an interactive process managed by a client side user interface as opposed to full data download systems traditionally used. According to one embodiment, the UI 107 (FIG. 1) comprises a Flash-based browser, which eliminates the need for a plug-in on the client machine. The contact sheet images provide a navigable interface to switch between views and also to correlate the content with the streaming micro-file content that creates higher resolution zoom views as indicated by block 210.

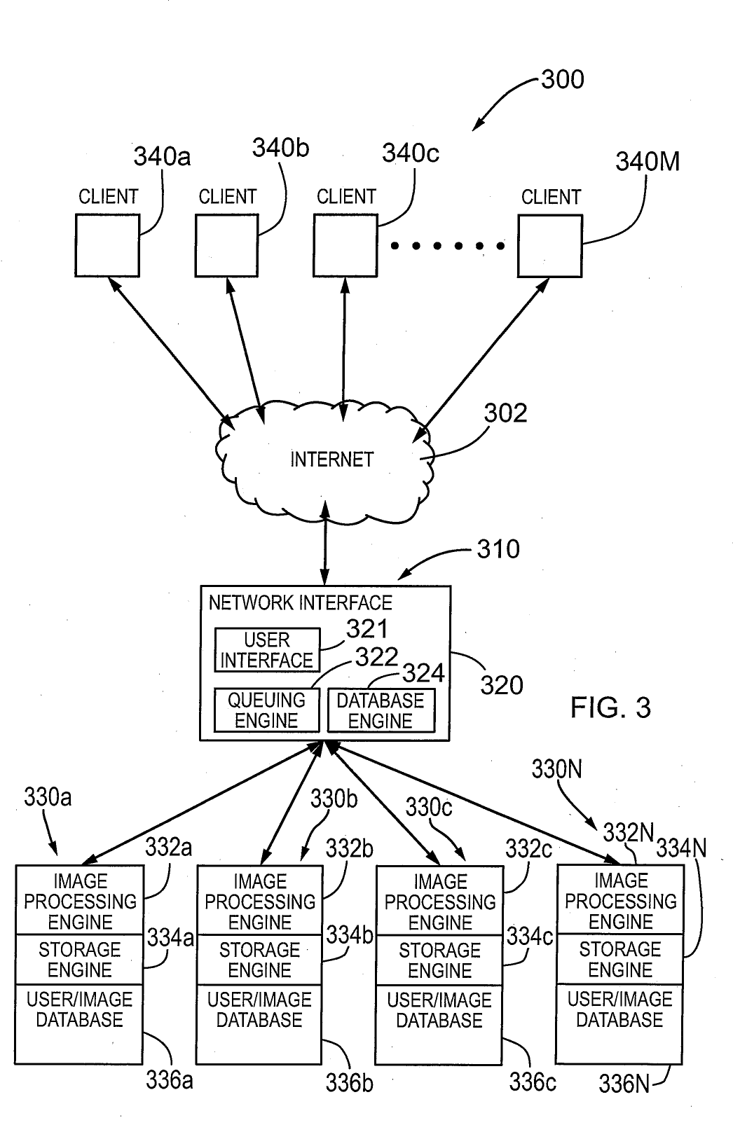

Reference is next made to FIG. 3, which shows a network-based interactive image management system according to another embodiment of the invention and indicated generally by reference 310. The network-based interactive image management system 310 may be implemented as a web-based system on the Internet 302 as depicted in FIG. 3 and is indicated generally by reference 300.

As shown in FIG. 3, the network-based interactive image management system 310 comprises a network interface or module 320 and a server 330. According to an embodiment, the network-based interactive image management system 310 comprises a distributed architecture or configuration with several servers 330 (e.g. N scalable servers), indicated individually by references 330a, 330b, 330c to 330N in FIG. 3. The network interface 320 provides an interface between the interactive image management system 310 and one or more clients 340, indicated individually by references 340a, 340b, 340c to 340M in FIG. 3. According to one embodiment, the network interface 320 comprises a web-based implementation and the network interface 320 provides a multi-browser capable web interface to the client(s) 340 via the Internet 302.

Referring to FIG. 3, the network interface or module 320 comprises a user interface process or engine 321, a queuing engine 322 and a database engine 324 according to an embodiment. The network interface 320 may be implemented on a computer or processing unit separate from the servers 330 or according to another embodiment as part of one or more of the servers 330. The queuing engine 322 is implemented to provide a mechanism to allow the image processing functions to be distributed over one or more of the servers 330, and according to an aspect provides n^{th}-degree scalability. As shown, each of the servers 330 is implemented according to an embodiment to include an image processing engine indicated generally by reference 332. According to another embodiment, one or more of the servers 330 may include an image storage engine 334. One or more of the servers 330 may also include a memory or storage module for storing an image database and/or user database, indicated generally by reference 336. The image storage engine 334 facilitates retrieval of images, e.g. component images for an image set, for processing by one or more of the image processing engines 332, for example, in a distributed processing arrangement. According to an embodiment, the image processing engine 332 is implemented in a manner similar to that described above and for a distributed processing arrangement includes the capability to perform pre-assessment and pre-processing functions, such as, normalization, segmentation and cropping, of the image sets.

The image management system 310, i.e. the network interface 320, the user interface process 321, the queuing engine 322, the database engine 324, the image processing engine 332, the image storage engine 334 and the user/image database 336 may comprise one or more software processes and data files. Any suitable programming language can be used to implement the processes and data files. For convenience, the processes and data files and the like may be referred to as software objects, components or modules. It is however to be appreciated that the use of the term “object” is not to be construed in a limiting sense, such as being strictly limited to “software objects” referred to in object oriented programming languages. Furthermore, while software objects are utilized according to embodiments of the present invention, at least some or all of the software objects may be hard-coded into central processing units and/or non-volatile memory devices in the system 310.

According to one embodiment, the network interface 320 comprises one or more software objects or modules for managing and displaying user information, image sets and/or accounting information. The network interface 320 also provides an interface to the image processing engine 332, the image storage engine 334 and the image database 336 running on the server(s) 330.

The software objects for the network interface 320 may comprise a user authentication engine, a session engine, and an accounting engine. According to one embodiment, the network interface 320 interacts with clients 340 through HTTP sessions, and is implemented using HTML and/or AJAX programming languages to display the command end user interfaces. The user interfaces include a “Welcome Screen”, an “Upload Screen”, a “Manage Previous Sets” screen, and a “Help” screen. The network interface 320 may also include an “Administration Interface” which comprises an “Administration” screen, a “User Sessions” screen, and a “Statistics” screen. The Administration screen provides the functionality to add, edit or remove users and clients. The User Sessions screen provides the functionality to display log entries. The Statistics screen provides the functionality to display statistics, such as, storage (i.e. total, free, used, percent used, average image set size), bandwidth (i.e. average, maximum upload speed and minimum upload speed), and credits (i.e. issued, used, outstanding). The user interfaces may be implemented in conjunction with the user interface process 321.

The database engine 324 comprises one or more tables for storing information about users and clients. The database engine 324 also includes an images table which contains data about uploaded image sets (e.g. image date, file name, file size, file directory, upload rate) and the current processing status (e.g. uploading, processing, published, removed, error).

The image processing engine 332 and the queuing engine 322 provide the functionality for image processing and manipulation. According to an embodiment, the image processing engine 332 is implemented to provide an instance for each pending queue. Each instance of the image processing engines 332 is configured with a directory for new incoming files and once a new file arrives the image processing engine 332 starts processing the image file. The image processing engine 332 is configured with location information for storing/writing the completed image sets. The image processing engine 332 may also be configured with a template flash interface which is used to present the image sets, for example as described above.

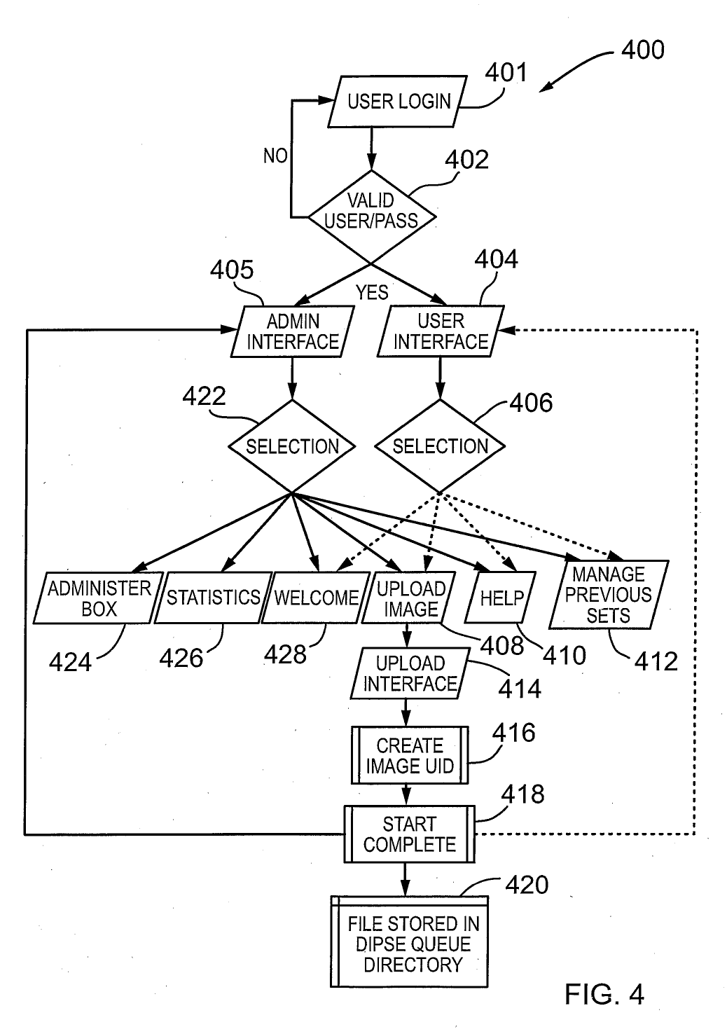

Reference is next made to FIG. 4, which shows a process for an upload session using the network-based image management system 300. The process is indicated generally by reference 400 in FIG. 4. The first step comprises a user login operation (e.g. user login screen) as indicated by block 401. The client, i.e. user, is validated in block 402 and depending on the configuration, the user may access the user interface in block 404 or the administrator interface in block 405. If the user logs on as a client, the user is presented with a number of selection screens in block 406. The screens include an upload image screen 408, a help screen 410, and a manage previous image sets screen 412, as described above. If the user selects the upload image screen, an upload interface screen 414 is displayed, an image user identifier (UID) is created (block 416) and the image set is processed in block 418, and the file for the completed image set is queued and then stored in the image database 336.

Referring still to FIG. 4, if the user logs on as an administrator in block 402, then the administrator interface 405 is presented and the user selects (block 422) between an administrator screen 424, a statistics screen 426, and a welcome screen 428. According to an embodiment, the administrator user is also provided with the capability to access the upload image screen 408, the help screen 410 or the manage previous sets screen 412.

According to one aspect, the present invention provides a method and apparatus for a user to transfer independently sourced images to a predetermined location, automatically processed to enable the images to be transferable at high speed and enable a single end user or multiple end users to view, manipulate, or otherwise interact with, the data images through an end user interface enabling the end user to enjoy the benefits of enhanced resolution currently available in existing digital imaging hardware.

According to another aspect, the present invention provides a system and a method for the rapid and/or automated conversion of still image data to interactive high-resolution image data and data delivery such that a significant amount of content can be processed and viewed in real time online.

According to another aspect, the present invention provides a network, for example, web-based, image management system whereby images, for example, industrial or commercial images, can be imported and rendered into an image file in real-time. According to one aspect, the image file comprises high-resolution, interactive, three-dimensional images.

The present invention may be embodied in other specific forms without departing from spirit or essential characteristics thereof. Certain adaptations and modifications of the invention will be obvious to those skilled in the art. Therefore, the presently discussed embodiments are considered to be illustrative and not restrictive.

What is claimed:

1. A system for creating image objects from a plurality of captured images, said system comprising:
an upload communication interface for receiving the captured images from a client location;
a processor, said processor including said communication interface and memory for storing said received images;
said processor including a component for converting said received images into a format compatible with said image object;
said processor including a download communication interface for providing a client with access to said image objects.

2. The system as claimed in claim 1, wherein said processor includes a component for establishing a processing order for said received images, and said component for converting said received images being responsive to said processing order.

3. A method for creating image objects from a plurality of captured images, said method comprising the steps of:
transferring the captured images to a processor;
said processor storing the captured images;
said processor converting said captured images into a format compatible with the associated image object;
said processor being responsive to a client request for retrieving said image object.

4. The method as claimed in claim 3, further including the step of establishing a processing order for said captured images, and said captured images being converted in accordance with said processing order.

5. The method as claimed in claim 4, wherein said step of downloading comprises downloading a plurality of micro-files for said image object.

6. A system for creating an image set from a plurality of captured images, said system comprising:
a network interface for receiving the captured images from one or more clients coupled to a network;
a processor having a queuing engine for queuing the captured images received from said one or more clients;
said processor including an image processing engine for processing the captured images into one or more image sets;
a storage device for storing said one or more image sets; and
said network interface including a module for retrieving said one or more image sets in response to a request from said one or more clients.

7. The system as claimed in claim 6, wherein said processor includes an image storage engine for storing said one or more image sets.

8. The system as claimed in claim 7, wherein said storage device comprises one or more scalable servers, and said image storage engine is operative for accessing said one or more image sets on one or more of said servers.

9. The system as claimed in claim 6, wherein said network comprises the Internet and said network interface comprises a user interface for a web-based implementation, and said user interface being operatively coupled to the Internet.

10. The system as claimed in claim 6, wherein said network interface comprises a user interface and a database engine, said user interface being operatively coupled to the Internet for communication with one or more users, and said database engine being operative to store information associated with said one or more users.

11. The system as claimed in claim 10, further including an image storage engine, and wherein said storage device comprises one or more servers, and said image storage engine is operative for accessing said one or more image sets on one or more of said servers.

12. The system as claimed in claim 11, wherein said one or more servers comprise a plurality of scalable servers.

13. The system as claimed in claim 12, wherein said processor comprises a processor having one or more executable processes, and said one or more executable processes are distributed over one or more of said plurality of scalable servers.

14. A method for creating an image set from a plurality of images wherein said images are received from one or more users via a network connection, said method comprising the steps of:
processing a request from the user wherein said request is received via the network connection;
establishing a network session for the user;
receiving one or more images from the user during said network session;
queuing said received images if images are received from more than one user;
processing said received images into one or more image sets; and
storing said one or more image sets in memory.

15. The method as claimed in claim 14, wherein said step of establishing a network session comprises processing a login request from the user.

16. The method as claimed in claim 14, further including the step of retrieving said one or more image sets in response to a request received from the user.

17. The method as claimed in claim 16, wherein said request is received during another network session.

18. The method as claimed in claim 16, wherein said step of storing comprises storing said image sets on one or more servers, wherein one or more of said servers comprises a scalable server.

19. The method as claimed in claim 16, wherein said step of queuing comprises queuing said received images if images are received during more than network session.
